(19) United States
(12) Patent Application Publication
(10) Pub. No.: US 2002/0035905 A1
(43) Pub. Date: Mar. 28, 2002

(54) Method for performing residue-free subdivision of a parallelepipedic block of a deep-frozen foodstuff into small parallelepipedic portions

(76) Inventor: Jorg Rosenberger, Reken (DE)

Correspondence Address: PROSKAUER ROSE, 1585 BROADWAY, NEW YORK, NY, 100368299

(21) Appl. No.: 10/000,988

(22) Filed: Nov. 15, 2001

Related U.S. Application Data
(62) Division of application No. 08/824,083, filed on Mar. 24, 1997.

(30) Foreign Application Priority Data
Mar. 27, 1996 (DE) 196 12 029.2

(51) Int. Cl. B26D 3/18

(52) U.S. Cl. 83/13; 83/408; 83/932

(57) ABSTRACT

A method for the residue-free subdivision of a parallelepipedic block of a deep-frozen foodstuff into small parallelepipedic portions of substantially identical format is performed by multistage sawing cuts. A conveyor system moves the block in a conveying direction, wherealong the block is initially subdivided into large thin slabs. The slabs, transported in the conveying direction of the sawing line, are then subdivided from above on a closed table top by circular saws equipped with very thin circular saw blades. The cutting loss during sawing is thereby minimized and the yield of portions optimized. Advantageously, any material accumulating during cutting is intercepted and applied to the deep-frozen foodstuff.

### RELATED APPLICATION

This application is a Divisional of U.S. application Ser. No. 08/824,083, filed Mar. 24, 1997, now allowed.

### BACKGROUND OF THE INVENTION

A proportion of the fish caught by the fishing industry is supplied in the form of deep-frozen blocks to factories for further processing. A standard parallelepipedic block has been developed having a length/width/thickness ratio in mm of 482:254:62.7—i.e., approximately 8:4:1. It is an aim of the further processing factories to produce from such a parallelepipedic block as many portions as possible, which must not fall below a given minimum weight.

The efforts which have been going on for about ten years to obtain as high a yield as possible from the subdivision of such a block into smaller portions have led to considerable successes. Both the use of thinner saws (DE 35 12 488 C2) and also the interception of the cut material accumulating during sawing and its application to the deep-frozen foodstuff (DE 35 12 488 C2; DE 39 26 533 A1; DE 40 09 405 A1) and also subdivision in combination with presses (DE 43 34 107 C1) have resulted in the successful residue-free subdivision of the deep-frozen block into small portions of the required final dimensions, the cutting loss being effectively kept low. For example, 441 fingers having a format of approximately 9.75:20.5:84 mm have been obtained from a block having the aforementioned dimensions in a method used in practice, wherein the block is first subdivided by band saws transversely of its longitudinal axis into two halves, whereafter the halves are subdivided transversely of their dividing plane into three bars of substantially square cross-section, which are then subdivided into three slabs, and finally subdivided into fingers by a circular saw. During the subdivision of the block down to the fingers, the cut material accumulating during sawing is intercepted and reapplied. The final cutting loss is approximately 3%, of which 80 to 90% is due to the band sawing.

It is an object of the invention to provide a method and a sawing line for the residue-free subdivision of a parallelepipedic block of deep-frozen foodstuff, more particularly fish, said method and said line enabling a higher yield of parallelepipedic portions to be obtained than is possible using the prior art methods and installations.

### SUMMARY OF THE INVENTION

This problem is solved by the invention, which provides a method for the residue-free subdivision of a parallelepipedic block of a deep-frozen foodstuff, more particularly fish, whose length is a multiple of its width and whose width is a multiple of its thickness, into a plurality of small parallelepipedic portions of identical format by multistage sawing, wherein smaller parallelepipedic units of identical format are obtained in each stage; in the first stage the block is subdivided on edge into slabs, while maintaining its length-to-width ratio, by means of a band saw, in the second and third stages after being placed separately, lying flat on a closed table top, the slabs are divided in two, transversely of the longitudinal axis, and in three, parallel with the longitudinal axis, to form bars by circular saws operative from above, or in converse sequence, namely in three, parallel with the longitudinal axis, and in two, transversely of the longitudinal axis, to form bars, and in the fourth stage the bars are supplied in the transverse position, lying flat on a closed table top, to a circular saw which is operative from above and in which the bars are simultaneously subdivided by parallel cutting to form the portions.

According to another feature of the method, the cut material accumulating during cutting at least at the circular saws, but preferably also at the band saw, is intercepted and applied to the deep-frozen foodstuff.

The problem is solved by the invention providing an apparatus in the form of a sawing line for subdividing a flat parallelepipedic block of deep-frozen foodstuff, more particularly fish, into a plurality of small parallelepipedic portions of identical format, comprising a number of serially disposed saws which are interconnected via conveyors and which divide the blocks into slabs, bars and portions, having the following features:

a) the first saw in the conveying direction is a band saw having at least two blades and a centering and guide unit which feeds the block to the saw blades in an upright position and parallel with its longitudinal axis,

b) a turning and separating device for the slabs leaving the first saw is disposed downstream of the first saw and upstream of the second saw,

c) the second saw and the third saw are circular saws which are disposed above a closed table top and are equipped with one or two parallel circular saw blades, the conveyor connecting the two saws being adjusted for rotating the slabs through 90° so that the slabs are fed to one of the two saws transversely of the longitudinal axis, and to the other of the two saws parallel with the longitudinal axis,

d) the fourth saw is a circular saw which is disposed above a closed table top and is equipped with a plurality of parallel circular saw blades, the upstream conveyor for rotating the bars fed to the fourth saw from the third saw through 90° being adjusted so that the bars are fed to the saw in the transverse position lying flat on the table top,

e) the circular saw blades are clamped between reinforcing discs, expect for a narrow edge corresponding to the thickness of the slabs and bars.

According to one feature of the invention, devices for intercepting the material accumulating during sawing and applying said material to the deep-frozen foodstuff are associated with at least the circular saws, but preferably also with the band saw.

According to the invention the use of band saw blades is limited to the first stage of the subdivision of the deep-frozen block. Since the use of the band saw in the first stage already produces parallelepipedic units whose thickness corresponds to the size of the parallelepipedic portions (fingers) in one axis, in all the following stages use is made of circular saws which cause a comparatively small cutting loss. While the use of a band saw means that it must be expected that cut material can also pass under the table top bearing the block, where it is substantially lost for recovery, the material cut by the circular saws remains above the closed table tops bearing the units to be subdivided and can be intercepted and reapplied by the known, established means. This is possible with a recovery quota of up to 98%. Moreover, since the units obtained after the first stage are relatively thin, in all the following stages use can be made of very thin circular saw blades of adequate rigidity, so that the cutting loss is inherently low. The use according to the invention of a band saw having a band thickness at the teeth tips of 0.4 mm exclusively in the first subdivision stage, and of circular saws having blade thicknesses of up to 0.65 mm, and substantial recovery of the cut material, produces a yield of 450 fingers having substantially identical dimensions and identical weight to those of the prior art fingers.

### BRIEF DESCRIPTION OF THE DRAWINGS

The invention will now be explained in greater detail with reference to the drawings, in which like reference numerals designate the same elements, and wherein:

FIG. 1 is a diagram illustrating the method of the staged subdivision of a deep-frozen block into smaller and smaller parallelepipedic units;

FIG. 2 is a diagrammatic plan view of a sawing line for the subdivision of a block;

FIG. 3 is a schematic side elevational view of a circular saw of FIG. 1, which includes a device for intercepting and applying cut material to the surface of a parallelepipedic unit of the deep-frozen foodstuff; and

FIG. 4 is a schematic side elevational view of a band saw of FIG. 1, which includes a device for intercepting and applying cut material to the surface of the parallelepipedic unit of the deep-frozen foodstuff.

### DETAILED DESCRIPTION OF THE PREFERRED EMBODIMENTS OF THE INVENTION

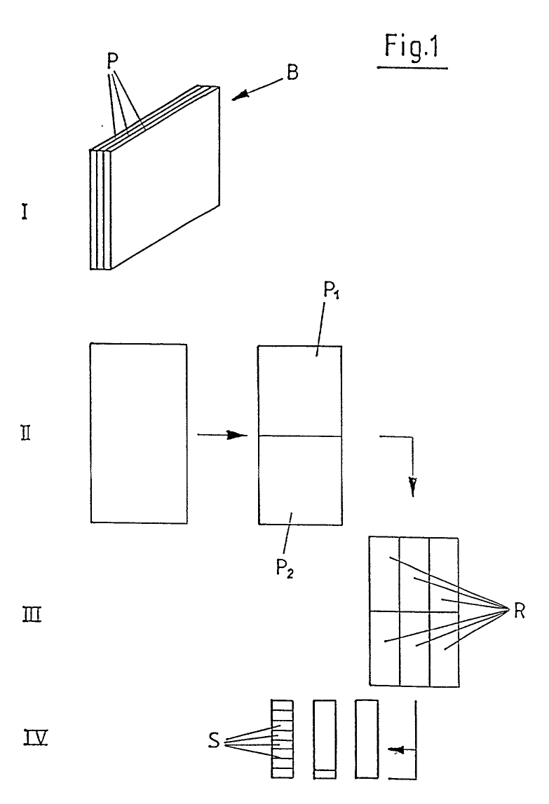

Referring to FIG. 1, a flat parallelepipedic block B supplied wrapped in a carton and having a length of 482 mm, a width of 254 mm and a thickness of 62.7 mm—i.e., a length/width/thickness ratio of substantially 8:4:1 is, after being unwrapped from the carton, fed on edge to a band saw having two blades having a thickness of approximately 0.4 mm at the tips of the twisted teeth. In the first stage I the block B is divided into three slabs P of identical shape, while maintaining the length/width ratio.

On their way to the second subdividing stage II the slabs P are turned—i.e., laid flat and fed separated in the transverse position to the circular saw which subdivides the slabs P into two smaller slabs P₁, P₂ of identical size.

On their further way to the third subdividing stage III the direction of movement of the slabs is rotated through 90°. In the third subdividing stage III the bisected slabs P₁, P₂ are divided in three by means of a circular saw equipped with two blades, so that six bars R are produced from the slabs P.

On their way to the fourth and last subdividing stage IV the bars R are separated and rotated through 90° in their conveying direction, so that they are fed lying flat and in the transverse position to a circular saw having a plurality of blades which subdivides the bars R into a plurality of fingers S.

In each stage during sawing the cut material is intercepted and applied to the surface of the units to be divided or already divided upstream or downstream of the saw.

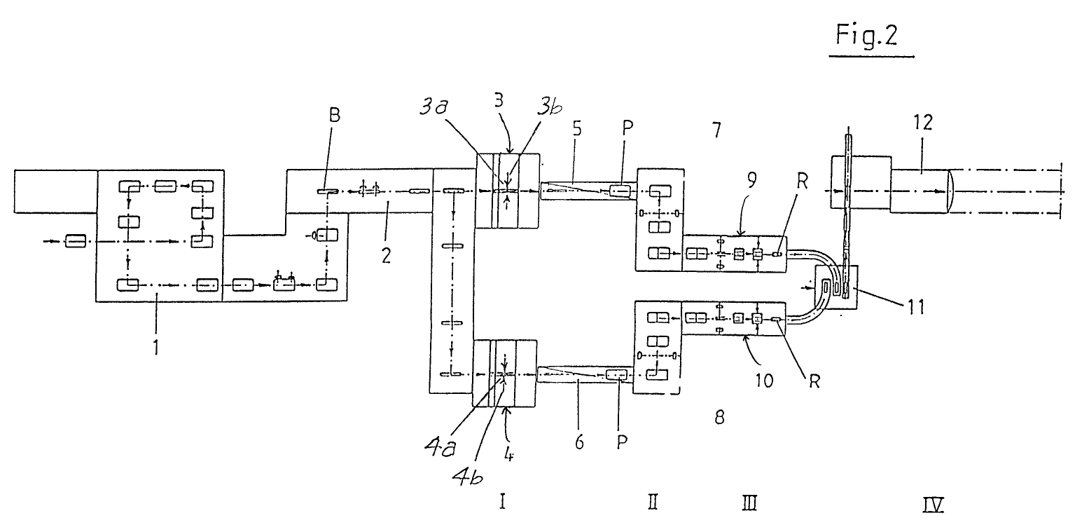

Referring to FIG. 2, a known system 1 for unwrapping a block of deep-frozen foodstuff supplied in a carton (EP 0 489 279 C2) precedes an installation for subdividing said block of deep-frozen foodstuff. The unwrapped block B passes on edge, standing on its long narrow side, to a conveyor 2 by which the blocks arriving in a single row are divided into two rows, to adapt the flow speeds of the unwrapping station 1 and the following subdividing stages.

Standing on edge, the blocks B pass from the conveyor 2 to band saws 3, 4 which each have two blades and centering and guide means which seize the wide sides of the blocks B. Band saws are suitable such as those known from DE 39 26 533 A1 or DE 40 09 405 A1. Suitable centering and guide means are those disclosed in DE 40 01 050 C2. At the band saws 3, 4 the blocks B are subdivided into three slabs P, while maintaining their width/length ratio. In the following conveyors 5, 6, which operate as a turning and separating device, the slabs P are turned—i.e., laid flat, and separated. After being rotated through 90° in the conveying direction, the slabs P arrive in the transverse position and lying flat on closed table tops and are guided laterally and centered at circular saws 7, 8 disposed above closed table tops.

The slabs P thus divided into two halves of identical size, only differing from one another by the width of a portion (finger), are rotated through 90° in the conveying direction by further conveyors and pass laterally guided and centered to further circular saws 9, 10 which are disposed above closed table tops and each of which have two blades, so that at the end of the subdividing stages II, III bars R are obtained which are fed in the transverse position to a stacking system 11, from where they pass in the transverse position to the final subdividing stage IV having a preceding bar-separating device and a circular saw 12 disposed above a closed table top and having a plurality of blades disposed parallel one beside the other, the bars being subdivided into fingers at this place.

The guide and centering means associated with each circular saw 7, 8, 9, 10, 12 are substantially identical with the aforementioned known guide and centering means on the band saw 3 of FIG. 2. The circular saws preferably have the construction known from DE 35 12 488 C2, and as depicted in FIG. 3. Each circular saw blade 13 has a diameter of over 100 mm and is clamped between two reinforcing plates or disks 14 (only one shown) leaving only a narrow outer edge free having a width W which is only slightly greater than the thickness t of the slabs P. This allows the use of very thin saw blades of 0.6 mm or only slightly larger, set with diamond chips. Due to the closed table top T, the cut material accumulated during sawing remains above the table top T and is intercepted by a hood 15 and applied by means of blown air and other application means, for example, a roller 16, to the surface of the deep-frozen material, as is known, for example, from DE 35 12 488 C2.

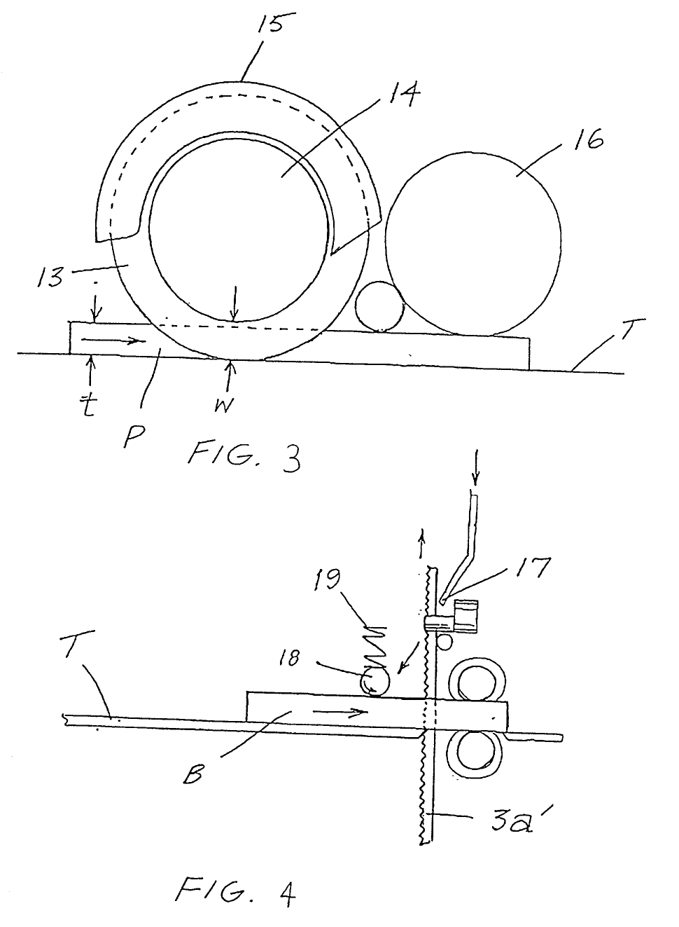

An analogous approach for intercepting and applying cut material to the surface of the parallelepipedic unit may be also implemented in connection with the first stage I, in which a parallelepipedic block B is fed to band saws 3, 4. A typical arrangement, as disclosed for example in DE 39 26 533 A1 mentioned earlier herein, is shown in FIG. 4. Although described relative to saw 3, the arrangement is equally applicable to saw 4. Saw blades 3a, 3a′ (only 3a′ being seen) are driven in an upward direction, cutting block B as it is moved rightward atop table T. The saw blades 3a, 3a′ are disposed in the path of a blowing medium stream emanating from a nozzle 17 corresponding to each of the saw blades 3a, 3a′. A contact pressure roller 18 is urged against block B by a spring 19. The blowing medium stream is directed to a side of the contact pressure roller 18 adjacent the saw blades 3a, 3a′, as indicated by the downward arrow, such that detached foodstuff adhering to the saw blades 3a, 3a′ is carried by the medium stream and applied to the contact pressure roller 18, which in turn applies and smooths the material to the surface of the block B.

1. A method for the residue-free subdivision of a parallelepipedic block of deep-frozen foodstuff into a plurality of small parallelepipedic portions of substantially identical format, comprises the steps of:
a) in a first sawing stage, subdividing the block conveyed on an edge into slabs by means of a band saw, wherein a length-to-width ratio is maintained,
b) in a second sawing stage, dividing the slabs, placed separately and lying flat on a closed table top, into two smaller slabs, transversely of a longitudinal axis of the slabs, my means of first circular saws operative from above,
c) in a third sawing stage, dividing the slabs in three parts, parallel with the longitudinal axis of the slabs, by means of second circular saws operative from above, forming bars, and
d) in a fourth sawing stage, subdividing the bars conveyed in a transverse position and lying flat on the closed table top, into portions, by parallel cutting by means of third circular saws operative from above.

2. A method according to claim 1, wherein during the second, third and fourth sawing stages, cut material accumulating at the first, second and third circular saws, respectively, is intercepted and applied to the deep-frozen foodstuff.

3. A method according to claim 1, wherein the foodstuff is fish.

4. A method for the residue-free subdivision of a parallelepipedic block of deep-frozen foodstuff into a plurality of small parallelepipedic portions of substantially identical format, comprises the steps of:
a) in a first sawing stage, subdividing the block conveyed on an edge into slabs by means of a band saw, wherein a length-to-width ratio is maintained,
b) in a second sawing stage, dividing the slabs, placed separately and lying flat on a closed table top, into three parts, parallel with a longitudinal axis of the slabs, by means of first circular saws operative from above,
c) in a third sawing stage, dividing the parts of the slabs into two, transversely of the longitudinal axis of the parts of the slabs forming bars, by means of second circular saws operative from above, and
d) in a fourth sawing stage, subdividing the bars, conveyed in a transverse position and lying flat on the closed table top, into portions, by parallel cutting by means of third circular saws operative from above.

5. A method according to claim 4, wherein during the second, third and fourth sawing stages, cut material accumulating at the first, second and third circular saws, respectively, is intercepted and applied to the deep-frozen foodstuff.

6. A method according to claim 4, wherein the foodstuff is fish.
